(19) United States
(12) Patent Application Publication
(10) Pub. No.: US 2005/0107024 A1
(43) Pub. Date: May 19, 2005

(54) Coin supply sensor for coin dispenser canister

(76) Inventors: Victor A. Quattrini, Merrimac, MA (US); Robert J. Pitman, Beverly, MA (US); Hamlin Peterke, Exeter, NH (US)

Correspondence Address: PERMAN & GREEN, 425 POST ROAD, FAIRFIELD, CT, 06824, US

(21) Appl. No.: 10/713,309

(22) Filed: Nov. 14, 2003

(51) Int. Cl. G07D 9/00

(52) U.S. Cl. 453/16

(57) ABSTRACT

A sensor array is described for monitoring the status of coins in a coin dispenser canister. The sensor array is constructed to be mounted on one side of a stack of coins and generate a signal when light is reflected off the coins. Such sensor arrays may be positioned to indicate multiple conditions relative to the inventory of coins in the dispenser canister.

### BACKGROUND OF THE INVENTION

1. Field of the Invention

The invention is related to automatic coin dispensers having canisters which contain an inventory of coins in stacks. More specifically it relates to sensing low coin or fill level positions of a stack of coins in the canister.

2. Brief Description of Related Developments

Prior systems are generally designed to use transmissive optical sensors to generate a low coin warning signal as the coin supply in a dispenser stack is depleted. Transmissive optical embodiments require that physically separate emitter and collector arrays be arranged on opposite sides of the coin column to provide trip point status. This literally doubles the supporting hardware required (boards, mounting features, cables, connectors), and limits positional flexibility since the coin stack must be “jacketed” or covered on both sides with sensors (see FIG. 1). It is a purpose of this invention to generate a coin supply level signal by using sensors which operate in reflective mode. It is a purpose of this invention to construct a sensor array that can be mounted on one side of the stack of coins.

Trip-point based coin detection is, in general, used to indicate low coin warning status when the coin inventory is at or near the point of depletion. Detection at different stack positions, i.e., further up the coin column, is not practical because of the packaging difficulty and numerous negative tradeoffs associated with surrounding the column with sensors in the upper regions of the coin stack. This difficulty is eliminated by the implementation of one-sided sensing techniques.

A common characteristic in the use of coin dispensers is that it is neither practical nor reliable to depend on the end user for a uniform starting inventory (fill level) for the canister or similar coin carrying apparatus. If a reliable starting inventory can be confirmed for each canister then exact inventory status during operation from that point forward can be known at all times via “coin counting” or decrementing from an initial value as dispensing occurs. It is a purpose of this invention to provide signals indicative of fill level and/or a depletion signal.

### SUMMARY OF THE INVENTION

The reflective optical sensor of this application is unique in that it is able to sense the coin stack, while the complete sensor is positioned only on one side of the coin stack. A single sensor board assembly carries both an LED emitter and a photocell collector for each coin stack. In the presence of a reflective surface within sensing range (the stack of coins), light from the LED is reflected and collected by the photocell providing a voltage signal indicating the status “coins present”. In the absence of a reflective surface within sensing range the photocell returns a different voltage signal indicating the status “coins not present”. The light is transmitted and reflected through an aperture mask, which functions to isolate the LED from the photocell to avoid “line of sight” interference between the transmitted and reflected light. In this way only reflected light emanating from the LED is available to the photocell.

### BRIEF DESCRIPTION OF THE DRAWINGS

The sensor system of this invention is explained in more detail below with reference to the accompanying drawing, in which:

FIG. 1 is a schematic illustration of a low coin sensor of the prior art;

FIG. 2 is a perspective view of a coin dispenser;

FIG. 3 is a block diagram of a control system for a coin dispenser;

FIG. 4 is a schematic illustration of the coin sensor of this application;

FIG. 5 is a perspective view of the sensor mask for the coin sensor of this application; and

FIG. 6 is a schematic illustration of a sensor system including a fill sensor and a depletion sensor.

### DESCRIPTION OF THE PREFERRED EMBODIMENT

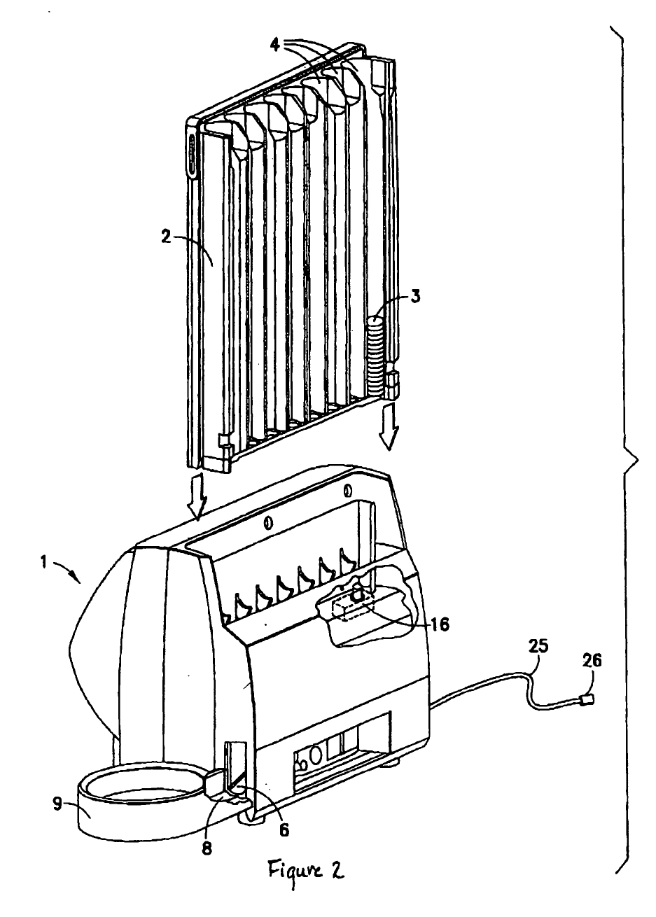

The coin supply sensor of this invention is designed for use in a coin dispenser 1, an example of which is shown in FIG. 2. A dispenser of this type is described in detail in commonly owned, copending U.S. application for patent Ser. No. 10/199,204. The disclosure of which is incorporated into this application by reference. Coin dispenser 1 includes a coin canister 2 which contains a supply of coins divided by denomination into multiple stacks 3. Each stack of coins is inserted into a cylindrical column shaped receptacle 4 from which the coins are dispensed by the action of a solenoid powered striker (not shown). The striker engages the lower most coin through an opening in the bottom of canister 2. The lower most coin is pushed out of receptacle 4 through an opening at the bottom of the column of coins onto a ramp 6 which allows the coin to travel out of the coin dispenser.

The ramp 6 may interface with a coin dispenser cup 9 in a stand alone application or with a host device delivery system which may consist of a chute mounted within a frame of the host device (not shown). The host device can be adapted for a wide variety of applications, for example point of sale terminals, cash registers, automated teller machines, automated check out terminals, kiosks and the like.

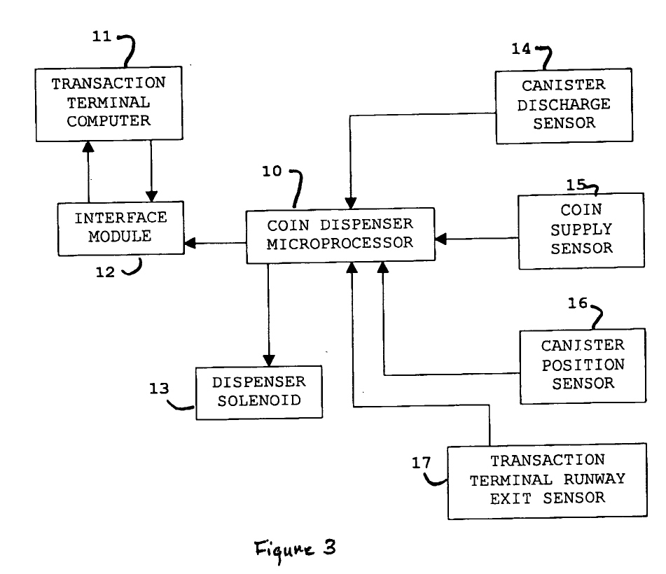

As shown in FIG. 3, coin travel monitoring may be performed by a combination of sensors 14-17 strategically placed within the dispenser or host system to track the progress of coins through the coin dispenser 1 and the host transaction terminal. The sensor of this application is designed to sense the presence of coin in the supply canister receptacles 4.

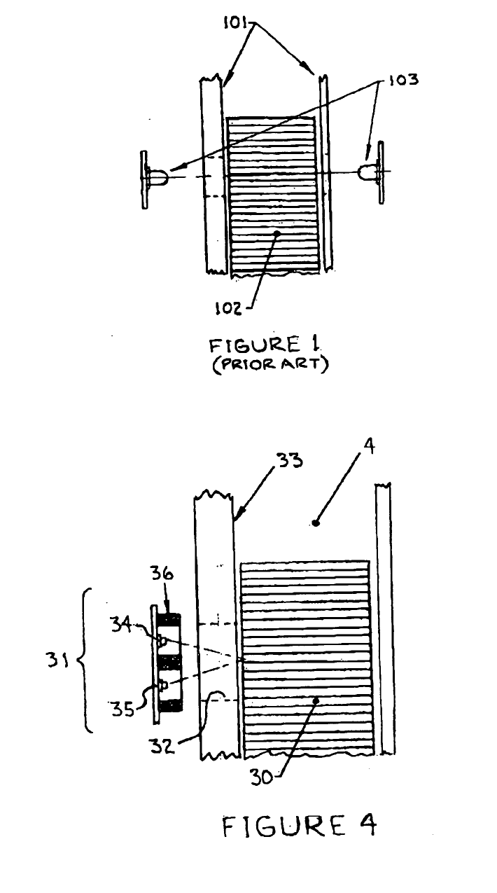

A typical low coin sensor of prior art coin dispenser systems is shown in FIG. 1. The walls 101 of a coin dispenser canister contain a stack of coins 102. A photo diode transmitter/phototransistor receptor pair 103 is mounted on either side of the stack so that the coins in the stack will interrupt the reception of the light beam transmitted from one side of the stack to the other.

According to the preferred embodiment of this invention as shown in FIG. 4, a stack of coins 30 is present in cylindrical receptacle 4. A sensor 31 is mounted on one side of receptacle 4, adjacent an access port 32 constructed in the wall 33 of receptacle 4. Sensor 31 consists of a photodiode transmitter 34 and phototransistor receptor 35 mounted adjacent to each other to enable light to be transmitted and reflected through access port 32. In the preferred embodiment, the diodes 34 and 35 of the sensor are positioned above and below each other.

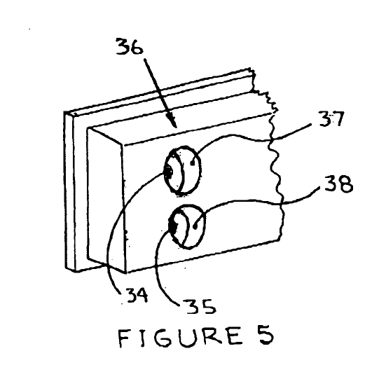

The sensor pair 34 and 35 are enclosed by a mask 36 as shown in FIG. 5. Mask 36 is constructed having a pair of spaced apart apertures 37 and 38 which are aligned respectively with the transmitter 34 and receptor 35. Apertures 37 and 38 have sufficient depth and spacing to prevent interference between transmitted and reflected light. Phototransistor receptor 35 is thereby isolated from receiving light directly from photodiode transmitter 34.

The sensor array 31 is connected, as part of the coin supply sensing system 15, to coin dispenser microprocessor 10. This can be accomplished through a bus or directly, depending on the structure of the coin dispenser.

In operation infrared light is transmitted by photodiode transmitter 34 into the cylindrical receptacle 4 through mask 36 and access port 32. In the event that a stack of coins is present, the infrared light will be reflected and picked up by phototransistor receptor 35. Receptor 35 will generate a voltage signal of a first value V₁ upon the receipt of reflected light. Signal V₁ would indicate that there are coins present in the receptacle 4, at the location of the sensor array 31. In the event that no light is reflected, receptor 35 will generate a different voltage signal of a second value V₂ which indicates that the coins are not present.

These signals are processed by coin dispenser processor 10 to initiate a variety of functions, for example: to set off a refill alarm and disable the coin dispenser; to indicate a near depletion alarm; or to indicate filled to capacity. The function would depend on the position of the sensor 31 relative to the stack of coins 30. The filled signal could be used to start a decremental accounting algorithm which would keep track of coin inventory. Sensor 31 may be mounted at a predetermined height relative to stack 30 and the predetermined height could be correlated to a set value of coin. Processor 10 would then be able to translate a sensor signal into coin value as a check for accounting control.

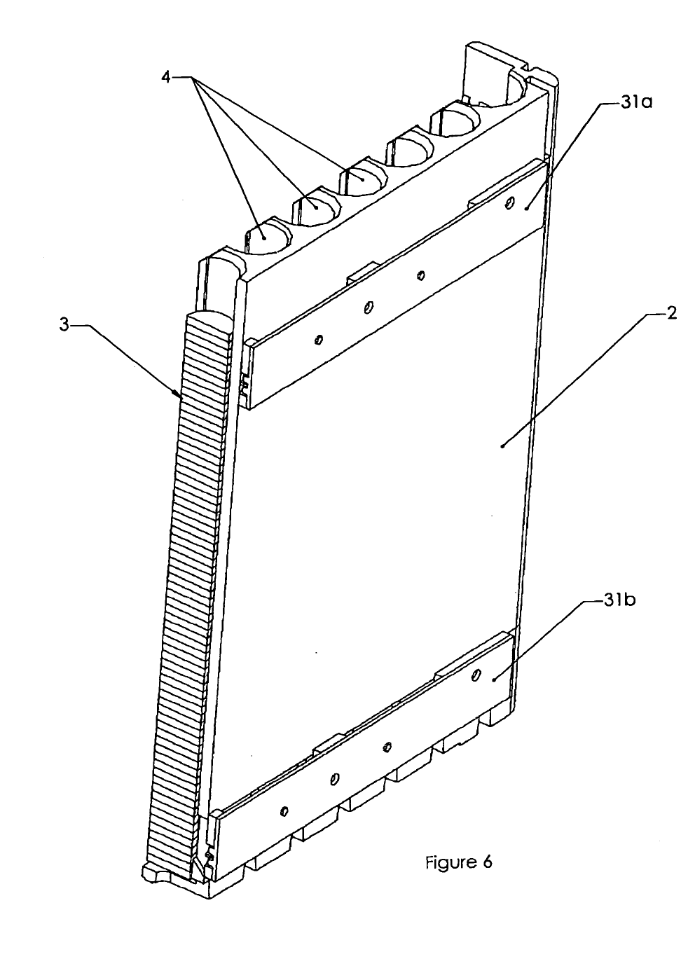

As shown in FIG. 6, multiple sensors could be placed at various positions relative to the stack of coins 30. Depending on the location of the sensors 31a and 31b an assortment of indications are possible. Sensor 31a, placed at the top of the columnar receptacle 4, would indicate when the receptacle is full. This would allow the start of an accurate accounting cycle based on counting the number of coins dispensed. Positioning sensor 31b at the bottom of columnar receptacle 4 would result in a depletion signal. A sensor 31c (not shown) may be positioned slightly raised from the bottom to indicated a near depletion condition. In the embodiment shown in FIG. 6, a two sensor system is used to provide a filled signal and a depletion signal.

The ability of the sensor of this application to function from only one side of the coin stack creates enhanced positional flexibility that can be utilized to provide coin inventory tracking through the use of early or multiple trip points. The prior art systems dealing with trip-point based coin detection is used to indicate low coin warning status when the coin inventory is at or near the point of depletion. Such systems could not provide early trip-point detection (further up the coin column) because of the packaging difficulty and numerous negative tradeoffs associated with surrounding the column with sensors in the upper regions of the coin stack. This difficulty is eliminated by the implementation of one-sided sensing techniques, according to this invention.

1. In a coin dispenser for dispensing a supply of coins from a receptacle, a sensor for detecting the presence of coins in the receptacle comprising:
at least one sensor mounted on one side of said receptacle, said at least one sensor further comprising:
a light transmitting device for transmitting light into said receptacle, wherein said light is reflected off said coins, when present; and
a light receiving device for receiving the reflected light, when coins are present, and generating a first signal, when coins are present, and a second signal when coins are not present.

2. In a coin dispenser for dispensing a supply of coins from a receptacle, a sensor for detecting the presence of coins in the receptacle, as described in claim 1, wherein said light transmitting device is a photodiode transmitter and said light receiving device is a phototransistor receptor.

3. In a coin dispenser for dispensing a supply of coins from a receptacle, a sensor for detecting the presence of coins in the receptacle, as described in claim 1, wherein said coin supply is arranged in a stack of coins, and wherein said sensor is positioned at a predetermined height to indicate the presence or absence of coin at said predetermined height.

4. In a coin dispenser for dispensing a supply of coins from a receptacle, a sensor for detecting the presence of coins in the receptacle, as described in claim 3, wherein said predetermined height is correlated to a predetermined value of coin.

5. In a coin dispenser for dispensing a supply of coins from a receptacle, a sensor for detecting the presence of coins in the receptacle, as described in claim 3, wherein said predetermined height is at the top of the stack.

6. In a coin dispenser for dispensing a supply of coins from a receptacle, a sensor for detecting the presence of coins in the receptacle, as described in claim 3, wherein said predetermined height is at the bottom of the stack.

7. In a coin dispenser for dispensing a supply of coins from a receptacle, a sensor for detecting the presence of coins in the receptacle, as described in claim 3, wherein said predetermined height is between the bottom and top of the stack.

8. In a coin dispenser for dispensing a supply of coins from a receptacle, a sensor for detecting the presence of coins in the receptacle, as described in claim 1, further comprising an access port constructed in the receptacle aligned with the sensor to allow the transmission and reflection of light through the receptacle.

9. In a coin dispenser for dispensing a supply of coins from a receptacle, a sensor for detecting the presence of coins in the receptacle, as described in claim 1, further comprising a mask mounted on said sensor and having apertures constructed therein aligned with said transmitting and receiving devices, to isolate the receiving device from exposure to transmitted light prior to reflection.

10. In a coin dispenser for dispensing a supply of coins from a receptacle, a method of controlling the inventory of coins in said supply comprising the steps of:
transmitting light into the receptacle wherein said light will be reflected from said coins when said coins are present;
sensing the reflected light to determine the presence or absence of coins in the receptacle and generating a signal indicative thereof;
performing the above steps at a predetermined position in the receptacle to indicate a coin inventory event correlated to said predetermined position.

11. In a coin dispenser for dispensing a supply of coins from a receptacle., a method of controlling the inventory of coins in said supply, according to claim 10, wherein the steps of transmitting and sensing are performed at multiple predetermined positions.

12. In a coin dispenser for dispensing a supply of coins from a receptacle, a method of controlling the inventory of coins in said supply, according to claim 11, wherein said multiple predetermined positions are correlated to one or more events selected from the group consisting of:
filled to capacity;
near depletion; and/or depletion.

13. In a coin dispenser for dispensing a stack of coins from a receptacle, a method of accounting for the said coins as they are dispensed, comprising the steps of:
establishing a predetermined height of said stack of coins correlated to a predetermined number of coins in said stack;
sensing the presence of said coins at said predetermined height and generating a signal in response thereto;
storing the number of coins contained in a full stack of coins in response to said sensor signal; and
counting the number of dispensing operations and subtracting said number of dispensing operations from said stored number of coins in a full stack to determine the number of coins remaining in the stack.
